(19) United States
(12) Patent Application Publication
(10) Pub. No.: US 2010/0194770 A1
(43) Pub. Date: Aug. 5, 2010

(54) Method and arrangement for spatial illustration

(76) Inventor: Markus Klippstein, Jena (DE)

Correspondence Address: JAMES F MCLAUGHLIN, 11 Ashwood Lane, Brookfield, CT, 06804, US

(21) Appl. No.: 12/680,196

(22) PCT Filed: Sep. 24, 2008
(86) PCT No.: PCT/EP08/08059

§ 371 Date: Mar. 25, 2010

(30) Foreign Application Priority Data
Sep. 25, 2007 (DE) 10 2007 046 414.4

(51) Int. Cl. G09G 5/02; G06T 15/00

(52) U.S. Cl. 345/589; 345/419

(57) ABSTRACT

The invention relates to a method for the spatial display of a scene in which several views of the scene are displayed in succession on an image display device (2) with a planar grid of pixels. The invention also relates to an arrangement that is suitable for carrying out the method.

For each view, propagation channels are specified and assigned to them, which differ from the propagation channels for the other views. The propagation channels are switched to be transmissive or opaque to light by means of a controllable shutter (3), depending on which view is displayed on which pixel. The pixels are provided with radiation surfaces, whose share in width is not greater than the reciprocal value of the number of views, with reference to the width of a pixel or its surface area. Each view is displayed for a time T that is shorter than the time resolution of the human eye.

### FIELD OF THE INVENTION

The invention relates to a method for the spatial display of a scene in which several views Aₖ of the scene, with k=1, . . . , N and N>1, are displayed in succession on a planar grid of pixels Bᵢⱼ with rows i and columns j. The invention also relates to an arrangement that is suitable for carrying out the method.

### PRIOR ART

Prior art knows of many methods for the spatial display of scenes, i.e. of still or moving images, as well as arrangements that implement such methods. Therein, digitized images, resolved into pixels, are displayed on suitable display screens, for example, LCD or plasma screens that can be addressed pixel by pixel. Views of the scene to be displayed are shot from several angles or constructed by computation, and then displayed on the screen. To enable spatial viewing, one must ensure that the left eye sees a different view, or a different selection of views, than the right eye. This is achieved by combining the screen with a device that defines propagation directions or propagation channels on the one hand, and by displaying only part of the views at a time, on the other hand; i.e. a view is not displayed with full resolution.

Patent application JP 08-331605 A, for example, describes an arrangement that permits the display of stereoscopic images by means of a specially designed and controlled LCD screen. The color filters for the colors red (R), green (G) and blue (B) are arranged lengthwise on the LCD screen in the form of stripes. The views, in this case two or more views, are distributed to the respective R, G and B subpixels. This distribution is made in such a way that, with respect to a subpixel that displays part of a view for the left eye, the subpixels in the adjacent rows and columns of the LCD matrix display part of the view for the right eye. If exactly two views are used, only half of either view is shown. The respective imaging in the left or right eye, respectively, is effected by means of a structured barrier arranged in front of the LCD display. As a result, the strict division into views for the left and such for the right eye no longer applies, unless a viewer is in an exactly defined position.

Another arrangement is disclosed in U.S. Pat. No. 4,829,365. The screen described there comprises a structured illuminating unit, which may, for example, be provided with vertical lines that radiate light. Arranged in front of this illuminating unit is a light valve, i.e., an optical shutter, with which the transparency of individual pixels arranged in a grid on the surface of the light valve can be controlled. The illumination of these pixels is effected from the rear by means of the illuminating unit. Arranged in front of the shutter is a mask for increasing a viewer's parallax effect that permits spatial viewing. Here again, the views for the right and the left eye are displayed simultaneously, i.e. distributed to the pixels, so that they cannot be displayed with full resolution.

A similar arrangement is described in U.S. Pat. No. 5,036,385. This arrangement is provided with an internal structured illumination and a light valve or shutter. The individual elements of the background illumination, e.g., lines, can be controlled differently and light up at different times. Two views of a scene are displayed on the screen simultaneously, but illuminated at different times. The arrangement is designed in such a way that one view is seen by the left eye only, and the other view by the right eye only. Here again, the views are distributed to different lines although they are displayed one after the other and, thus, they are not displayed with full resolution.

Finally, EP 1662808 A1 discloses yet another arrangement for displaying stereoscopic images. In addition to an LCD screen, a barrier based on an LC panel is provided. This barrier acts as a light valve and can be controlled, so that the pixels of the LC barrier can be switched to be transparent or opaque. Images for the left and the right eye are displayed simultaneously; thus, a scene cannot be visualized with full resolution. Moreover, channel separation is not exact unless a viewer is in exactly defined positions.

With the known arrangements and methods for three-dimensional display, then, it is not possible to display a scene spatially with full resolution. This has a noticeable negative effect for a viewer, as the images partly seem to have a coarser structure.

### DESCRIPTION OF THE INVENTION

Therefore, the problem of the invention is to develop a method and an arrangement for spatial display, with which spatial views of a scene can be displayed without quality loss compared to a two-dimensional display, i.e. with full resolution, and preferably also with a separation of the channels for the left and the right eye, in any viewing position. Moreover, the arrangement should be easily manufacturable industrially, and with little effort, so that it can be made in large quantities and at reasonable cost.

This problem is solved by a method for the spatial display of a scene, in which several views Aₖ of the scene, with k=1, . . . , N and N>1 are displayed in succession on a planar grid of pixels Bᵢⱼ with rows i and columns j. In this method, the total number of the rows and columns defines a resolution, and the grid has a total surface area and each pixel Bᵢⱼ has a pixel surface area. The sum of all pixel surface areas yields, in essence, the total surface area of the grid. Each of the view Aₖ is displayed for a time T that is shorter than the time resolving power of the human eye. From radiation surfaces of the pixels Bᵢⱼ, light is radiated, i.e. emitted or transmitted, and to each view Aₖ there are assigned specified propagation channels for the radiated light that can be switched to be transmissive and opaque to light. The propagation channels assigned to a view Aₖ differ from the propagation channels for the other views, so that a viewer, on a time average, predominantly or exclusively sees bits of partial information of a first selection from the views Aₖ with one eye, and predominantly or exclusively sees bits of partial information from a second selection with the other eye, whereby a visual impression of space is made. Each selection of views may comprise one or several views. As a radiation surface of each pixel Bᵢⱼ, only a partial area is used, whose share in width is maximally 1/N, referred to the horizontal extension of the pixel surface area. In addition, at every time T, those propagation channels are switched to be opaque to light which are assigned to such views Aₖ that are not displayed at this time. As mentioned above, the time T is shorter than the time resolving power of the human eye, i.e., shorter than 1/16s. If the views are displayed over a longer time, the viewer will, as a result, see a jolt when the views change. The time may also be, for example, 1/24s or 1/48s, following the intervals used in professional movie films and in HD television. In the latter case, if two views are displayed, the first view, for example, is shown for 1/24s, and subsequently the other view for 1/24s. Over this time, the view is shown without interruption, i.e. continuously, as a rule.

Consequently, the light radiated by the radiation surfaces propagates only along those propagation channels that are assigned to the views displayed in the time T.

Preferably, the propagation channels are switched to be optically transmissive or opaque to light by means of a shutter with controllable shutter elements that is arranged before or behind the grid. This shutter also permits the directions of the propagation channels to be defined. The configuration of the propagation channels depends on the dimensioning of the radiation surfaces of the pixels, on the area opened by the shutter elements in the case of light transmittance, and on the distance of the shutter from the grid of pixels. The dimensions are, as a rule, adapted to each other in such a way that the propagation channels broaden towards a viewer in the manner of a fanned-out beam. In this way, different propagation channels are made to overlap, which causes the left and the right eye, on a time average, to see different sets of views. The width of the splitting is determined by the distance between the shutter and the grid of pixels on the one hand, and on the other hand by the position and size of the light-transmissive area of a shutter element relative to the radiation surface des respective pixel.

In a preferred embodiment, therefore, the shutter elements in the light-transmissive switching status open, for each of the respective pixels Bᵢⱼ, an area that has the height of the radiation surface and that has the width of the same save for a correction factor. The said correction factor is determined essentially in accordance with the intercept theorem as applied to parallax barriers, according to the description, e.g., in an article by Sam Kaplan in Journal of the SMPTE, Vol. 59, pages 11-21, published in 1952, and in such a way that the propagation channels taper towards the viewer. Of course it is also possible to apply a correction factor to the height of the said areas; this is reasonable if the radiation surfaces are not arranged as vertical stripes but are, for example, staggered segmentwise so as to suggest oblique stripes.

The invented method makes it possible, on the one hand, to achieve near-complete channel separation, but also, on the other hand, to display all views of the scene with full resolution. Full-resolution display can be achieved in two ways:

First, each of the views can be displayed for a time T with full resolution. In this way, all views are shown in succession, and each change of view is accompanied by a corresponding triggering of the shutter elements, which then open other propagation channels.

Secondly, it is possible to display several views simultaneously. In another configuration of the method, therefore, M of the views Aₖ, with M<N, are displayed simultaneously, and each of the M views Aₖ is displayed for a time greater than T, preferably between M*T and N*T, with full resolution on a time average. If, for example, two views are displayed simultaneously, an alternating distribution to the pixels Bᵢⱼ can be effected in such away that the pixels B_{i±1,j±1}, adjacent to a pixel Bᵢⱼ that displays partial information of a first view A₁, show partial information of the other view A₂. The propagation channels are switched accordingly. After a time T, matters are reversed, i.e. the pixels used to display partial information of the view A₁ in the first time now display partial information of the view A₂, and vice versa. In such a way, in a time of 2T, each of the two views is displayed with full resolution. Of course, the time T will be dimensioned so that the human eye does not notice the change.

The problem is also solved by an arrangement for three-dimensional display of a scene, comprising a image display device with a grid of pixels Bᵢⱼ with rows i and columns j, on which several views Aₖ of the scene with k=1, . . . , N and N>1 can be displayed in succession, each for a time T that is shorter than the time resolving power of the human eye, with the grid having a total surface area and each pixel Bᵢⱼ having a pixel surface area, the sum of all pixel surface areas yielding, in essence, the total surface area of the grid, and the pixels Bᵢⱼ having radiation surfaces by which light is radiated, i.e. emitted or transmitted. The arrangement further comprises control unit, which assigns each view Aₖ propagation channels for the radiated light, with the propagation channels assigned to one view Aₖ differing from the propagation channels for the other views, so that a viewer, on a time average, will see predominantly or exclusively bits of partial information of a first selection from the views Aₖ with one eye, and predominantly or exclusively bits of partial information from a second selection with the other eye, whereby a visual impression of space is made. Moreover, the arrangement comprises a controllable shutter for determining the propagation channels, which switches the propagation channels to be transmissive or opaque to light. The radiation surface of each pixel Bᵢⱼ is only a partial area of the pixel Bᵢⱼ, whose share in width is maximally 1/N, referred to the horizontal extension of the pixel surface area. Further, the shutter is controlled by the control unit in such a way that at every time T those propagation channels are switched to be opaque to light which are assigned to such views Aₖ that are not displayed at this time.

The radiation surfaces of the pixels, or the pixels themselves, may be designed to be transmissive, i.e. they are illuminated from one side with the light penetrating through the surfaces; but they may also de designed to be self-luminous. Thanks to the special dimensions of the radiation surfaces with regard to width and the corresponding triggering of a shutter matched to them, it is possible, on a time average, to display several views of a scene with full resolution, i.e. without loss of resolution for a viewer.

The image display device with the grid of pixels Bᵢⱼ may, for example, be a specially made LC panel, in which the pixels, on their surface, have the dimensions of the radiation surfaces and the spaces between den pixels are filled with structures that are opaque to light. To reduce the manufacturing cost, it is also possible to use commercial LC panels such as employed in flat-panel displays. In this case, other means must be used to ensure that light is radiated only from the radiation surfaces of the pixels Bᵢⱼ which are smaller than the pixel surface areas.

This can be achieved, for example, by providing the grid of pixels Bᵢⱼ or the image display device with a mask that covers the pixel surface areas in such a way that at least a share of (N−1)/N of their widths regarding the horizontal extension is covered by opaque material, whereas the remaining share is covered by transmissive material, with each share covered transmissively corresponding to one radiation surface. The radiation surface, then, has a width of 1/N relative to the width of the total picture. On these radiation surfaces, the N views are displayed one after the other. By means of a suitable shutter, which also has N settings for each pixel, different propagation channels are defined for each view; channel separation for the right and the left eye is essentially complete in this case. Instead of a mask, the pixels may configured accordingly, as mentioned above: they may be designed, if we regard the surface area of a pixel in common LC panels, be configured so that altogether only a share 1/N of the entire grid is used for radiation, with each of the pixels Bᵢⱼ radiating an approximately equal share.

As less light is radiated because the grid of pixels with is covered with a mask, one provides the side of the mask facing the image display device or the grid of pixels Bᵢⱼ with a mirror coating, so that the light that is not radiated from the radiation surfaces but hits the mask's mirror coating is reflected back. It can then be used for illumination again. The mask may also have mirror coatings on both sides, so that, for example, light reflected by the shutter can enter the LC panel again through the mask.

Whereas in the arrangement just described the mask is applied on the pixel surface areas, i.e. on the side facing the viewer, it is also possible to apply the mask on the rear side of the grid, i.e. on the side facing away from the viewer. The mask is then dimensioned in such a way that the pixel surface areas are illuminated only in the area of the radiation surfaces. In this case, the mask is, for the reasons mentioned, preferably provided with a mirror coating on its side facing an illuminating device, but it may also have mirror coatings on both sides.

The shutter is preferably provided with individually controllable shutter elements, preferably optoelectronic shutter elements based on liquid crystals. The shutter elements can individually be switched between the transparent and opaque statuses. The shutter is preferably arranged in front of the grid of pixels, as seen from a viewer's position. Equivalently to this and with equal effect, it may, however, also be arranged behind the grid of pixels. With a suitable configuration, e.g., in the manner of an LC panel, it can be applied directly on the image display device or the mask.

In a preferred embodiment of the invention, the optoelectronic shutter elements and the pixels Bᵢⱼ consist of materials whose optical refractive indices differ by less than 10%. If the mask does not simply leave the light-transmissive locations unto covered but is made of some transparent material there, the refractive index of this material preferably has also a value that differs by less than 10% from the refractive indices of the pixels or shutter elements. This condition is important in so far as the refractive indices have an effect on the position of the propagation channels and their divergence. This must allowed for in the design. Ideally, therefore, the refractive indices of the components mentioned are equal.

The pixels Bᵢⱼ are preferably arranged on the grid periodically and of polygonal shape. Obviously, other shapes are also applicable, and the pixels need not necessarily be arranged periodically, provided that this is taken into consideration in the design and in shutter control. However, with a regular polygonal design of the pixels one can have the total surface area of the grid completely occupied by pixels so that no vacant sites result. For example, the pixels Bᵢⱼ can be of rectangular or honeycomb shape. If they have a rectangular shape, the radiation surfaces have the same heights as the pixels Bᵢⱼ or the pixel surface areas. The widths of the radiation surfaces and of the pixels Bᵢⱼ have a ratio of 1/N. The “height” and “width” measures are to be understood relative to viewer standing in front of the image display device with the shutter, in the direction of a line normal to the screen.

In a particularly preferred embodiment of the invention, the shutter elements are shaped as stripes of vertical orientation, in which the width of one stripe, with a correction factor taken into account, corresponds essentially to the width of the radiation surfaces, and in which the number of stripes is at least N times the number of pixels Bᵢⱼ in each row i of the grid. In this way it is ensured that no two views use the same propagation channels; i.e. channel separation is complete. This is the case also if two views are displayed simultaneously as described above, because the propagation channels are switched accordingly, depending on whether the first or the second view is displayed on the pixel. Again, the correction factor can be determined by the aforementioned theory of parallax barriers; it depends essentially on the distance between the grid of pixels and the shutter, and on a given viewing distance and the mean interocular distance of the viewer's eyes. A vertical orientation of the stripes is most advantageous for three-dimensional display, as it intersects the line connecting the eyes of a standing or seated viewer at right angles; however, the shutter elements may obviously also be shaped in the manner of oblique stripes or have a size that corresponds to one pixel. Compared to the stripe shape, though, this has the disadvantage that a greater number of shutter elements have to be controlled.

In an expedient embodiment of the invention, the shutter and/or the image display device is provided with means for reducing unwanted light reflections, preferably at least one optical-interference antireflection coating layer.

The image display device may be configured, e.g., as an LCD color screen, as a plasma screen, as a projection screen or as an LED screen. Other possible versions are configurations as an OLED (organic light-emitting diode) screen, as an SED (surface-conduction electron emitter display) screen or as a VFD (vacuum fluorescence display) screen.

The pixels Bᵢⱼ are designed, e.g., as R (red), G (green) or B (blue) subpixels or as a combination of such subpixels. In particular, such a combination also comprises a combination of one each of these subpixels, i.e., one pixel. The pixels Bᵢⱼ may, however, also be designed as full-color pixels or combinations thereof, as it is the case, e.g., with projection screens.

### BRIEF DESCRIPTION OF THE DRAWINGS

Below, the invention will be explained in more detail on the basis of exemplary embodiments. In the accompanying drawings, which also contain features essential to the invention,

FIG. 1a illustrates the basic design of an arrangement for spatial display,

FIG. 1b illustrates an alternative arrangement,

FIG. 2 illustrates a grid of pixels for the display of four views,

FIGS. 3a-3d are sectional drawings illustrating the definition of propagation channels by a shutter for four views,

FIG. 4 illustrates another possibility of arranging the radiation surfaces on the pixels,

FIGS. 5a-d illustrate the corresponding positions of the shutter elements as seen from the viewer's side, and

FIG. 6 illustrates a grid of pixels on which several views are displayed simultaneously.

### DETAILED DESCRIPTION OF THE DRAWINGS

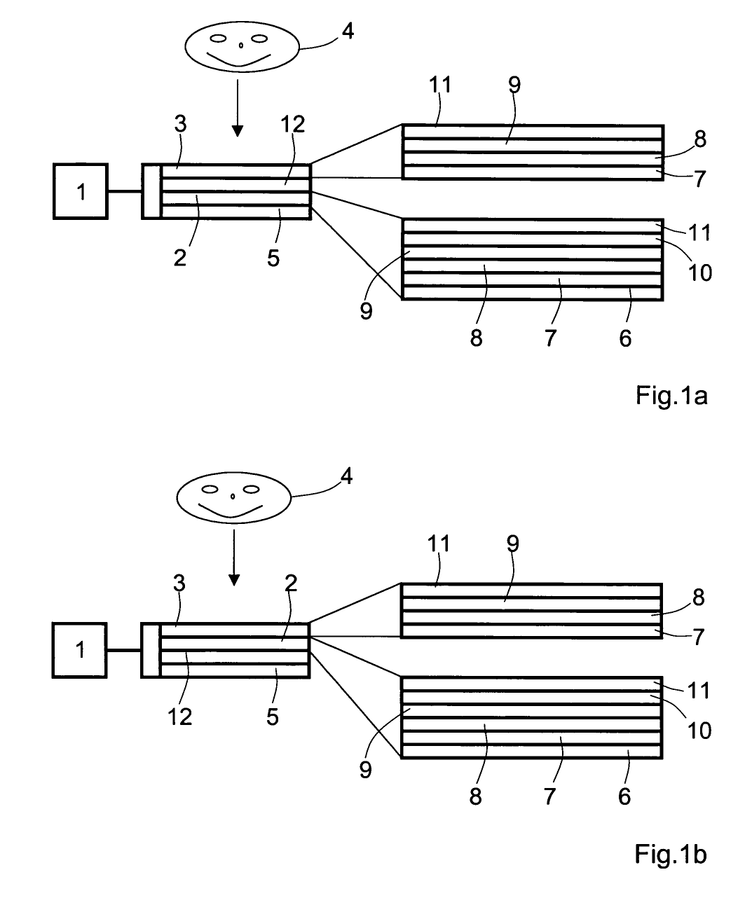

FIG. 1a and FIG. 1b show two versions of an arrangement for the three-dimensional display of a scene. The arrangement comprises a control unit 1, which, among other things, controls an image display device 2 and a shutter 3. The image display device 2 features a grid of pixels Bᵢⱼ with rows i and columns j, on which severak views Aₖ of the scene, with k=1, . . . , N and N>1, can be displayed in succession, each for a time T which is shorter than the time resolving power of the human eye. The grid has a total surface area, and each pixel Bᵢⱼ has a pixel surface area, with the sum of all pixel surface areas yielding, in essence, the total surface area of the grid. Moreover, the pixels Bᵢⱼ feature radiation surfaces from which light is radiated. The pixels Bᵢⱼ may be designed to be either transmissive or self-luminous. In the examples shown, however, the image display devices 2 are LC panels, which are illuminated by an illuminating device 5 from behind, as seen by a viewer 4; thus, the pixels Bᵢⱼ are transmissive. An image display device 2 which is designed as an LC panel typically shows the following sandwich-like design, which is shown enlarged on the right side of FIG. 1a and FIG. 1b. The light first hits a lower polarizing filter 6, which polarizes the light. A substrate on the lower polarizing filter 6 carries a thin-film transistor matrix 7, the upper side of which is provided with an electrode layer 8. Commonly, the material used for the electrodes is indium tin oxide (ITO), from which transparent electrodes can be fabricated. The electrodes are also arranged in the form of a matrix. On top of the electrode layer 8 there is a liquid crystal layer 9; the polarizing direction of the light linearly polarized by the lower polarizing filter 6 is rotated or not, according to the control. Subsequently, the light passes a color filter layer 10, which is also designed in the form of a matrix. Each element of this matrix corresponds to a subpixel. Applied on top of the color filter layer 10 there is an upper polarizing filter 11. The upper polarizing filter 11 also polarizes the light linearly. The polarizing directions of the upper polarizing filter 11 and the lower polarizing filter 6 may be oriented parallel or normal to each other. If they are oriented normal to each other, only the light whose polarizing direction has been rotated by the liquid crystal layer 9 can pass the upper polarizing filter 11. The light whose polarizing direction has not been changed cannot pass the upper polarizing filter 11. If the polarizing directions of the two polarizing filters 6 and 11 are parallel to each other, the situation is exactly reverse.

The arrangement is conceived in such a way that the radiation surface of each pixel Bᵢⱼ is only a part of the area of the pixel Bᵢⱼ, with a share in width that is maximally 1/N, referred to the horizontal extension of the pixel surface area. Obviously, the pixels may also be conceived to be as small as to make the radiation surface and the pixel surface area identical to each other, i.e. that the partial area is the whole area. As a rule, however, the image display device as just described will be a commercially available one, so that separate measures have to be taken to obtain the radiation surfaces. In the examples described, this is achieved in that a mask 12 is applied on the image display device 2. The mask may be applied on io the front side (relative to the viewing direction of the viewer 4) of the image display device 2, as shown in FIG. 1a, or on the rear side of the image display device 2, as shown in FIG. 1b. If the mask 12 is applied on the front side of the image display device 2, the mask covers at least a share of (N−1)/N of the width (referred to the horizontal extension) of each pixel surface area with opaque mask portions, whereas it covers the remaining share by transmissive mask portions. The share covered transmissively corresponds to one radiation surface. Further, the side of the mask 12 facing away from the image display device 2 may be provided with a mirror coating.

Whereas in the arrangement shown in FIG. 1a the mask 12 is applied on the front side of the image display device 2, i.e. the side facing a viewer 4, FIG. 1b shows an embodiment in which the mask 12 is applied on the rear side of the image display device 2. In this case it is dimensioned in such a way that the pixel surface areas are illuminated only in the area of the radiation surfaces. Concerning the mask 12, then, one must take into consideration that the light possibly is scattered within the image display device 2, even though the thickness is very small. In this case, the mask 12 may, in addition, be provided with a mirror coating on its side facing the illuminating device 5.

Arranged in front of the mask 12 or of the image display device 2 (as seen from the side of the viewer 4) there is the shutter 3. The shutter 3 is, in this case, provided with individually controllable optoelectronic shutter elements based on liquid crystals. Therefore, the design of the shutter 3 is similar to that of the image display device. A lower polarizing filter 6 is not required, though, as the light leaved the image display device 2 already in a polarized state. Therefore, the shutter also consists of a thin-film transistor matrix 7, on which there is applied an electrode layer 8 with electrodes based on indium tin oxide. On top of this there is a liquid crystal layer 9 with the individually controlled shutter elements. The shutter 3 is completed by an upper polarizing filter 11; a color filter is dispensable.

Advantageously, the optoelectronic shutter elements of the shutter 3, the mask 12 and the pixels Bᵢⱼ consist of materials whose optical refractive indices differ from each other by less than 10%. This is to be understood merely as a guide value; the abovementioned elements can also be matched to each other with greater differences, say, 25% or more, although with somewhat greater effort. In this way one can achieve that the refractive index transitions between image display device 2 and shutter 3 and, where provided, mask 12 are minimal. The refractive index transitions can also be minimized by suitable selection of the materials for the other components, too, such as polarizing filters 6, 11, thin-film transistor matrix 7 and electrode layer 8. Essential constituents, however, are the liquid crystal layers 9 and the mask 12. Especially the material of the mask 12, therefore, should be selected so that it matches the image display device 2 and the shutter 3 in the above sense.

Whereas in the present example, the image display device 2 described is an LCD color screen, other image display devices configured as a plasma, projection, LED, OLED, SED or VFD screen are also possible. In the present case, the pixels Bᵢⱼ are arranged periodically on the grid and of polygonal shape; they can also be designed, for example, as R (red), G (green) or B (blue) subpixels or as a combination thereof. To reduce unwanted light reflections, the shutter 3 or the image display device 2 or both may be provided, e.g., with an optical-interference antireflection coating layer.

Below, the mode of operation of the arrangement is explained in more detail.

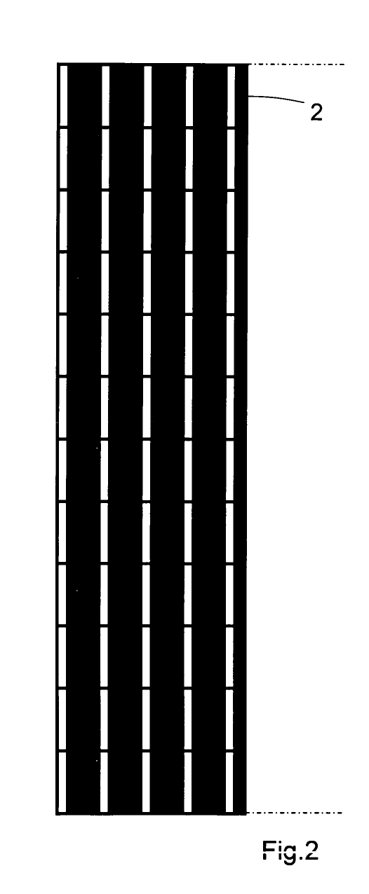

FIG. 2 shows a segment of the image display device 2 as seen from the front. The segment shows twelve rows i and five columns j with pixels Bᵢⱼ. The image display device 2 is designed for the display of four views (N=4) with almost complete channel separation. Therefore, only a fourth of each pixel Bᵢⱼ is transparent, represented by the white stripes, which correspond to the radiation surfaces. The remaining part is opaque, represented by the black areas. This is achieved by the application of a mask 12 on the image display device 2. The mask 12 is not shown in this illustration, though. Four views of the scene will be displayed on the pixels in succession, each for a time T. The control unit 1 assigns propagation channels for the radiated light to each view A₁ through A₄. The propagation channels assigned to a view Aₖ differ from the propagation channels for the other views, so that a viewer, on a time average, will predominantly or exclusively see bits of partial information of a first selection from the views Aₖ with one eye and predominantly or exclusively bits of partial information from a second selection with the other eye, whereby a visual impression of space results.

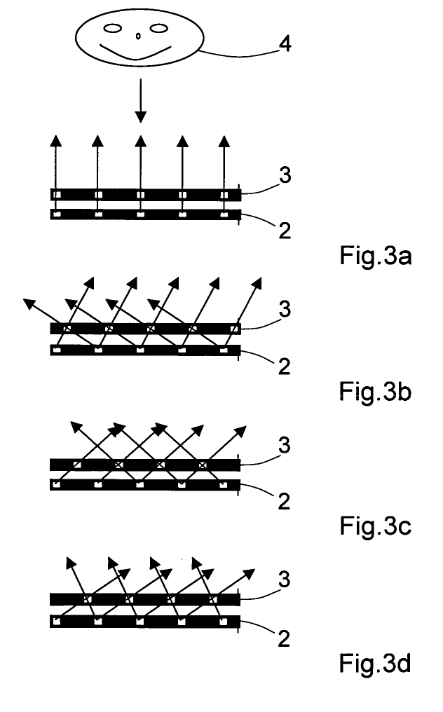

To achieve this, the shutter 3 is controlled by the control unit 1 in such a manner that, at every time T, those propagation channels are switched to be opaque to light which are assigned to such views Aₖ that are not displayed at this time. This is shown in FIG. 3a through FIG. 3d. Each of the FIGS. 3a through 3d shows the combination of image display device 2 and shutter 3 as a section, and a viewer 4 looking at the shutter 3. During a first time T, the view A1 is displayed. This is shown in FIG. 3a. A section has been made randomly through the image display device 2 and the shutter 3, so that in the top view one can see for a single row where light passes through the pixels Bᵢⱼ of the image display device 2 and which optical shutter elements of the shutter 3 are switched to be transmissive to light. If the shutter elements are designed as stripes of vertical orientation, the illustration is true for all sections. The width of one stripe, with a correction factor taken into account, corresponds essentially to the width of the radiation surfaces; the number of stripes is at least N times the number of pixels Bᵢⱼ in each row i of the grid. In the present case, then, the number of stripes or of the shutter elements is four times the number of pixels Bᵢⱼ per row. The correction factor takes into account that the shutter and the grid of pixels have a finite distance from each other, which is of importance for the propagation of the light, i.e., the divergence of the channels, and affects the perception by a viewer 4. The correction factor may be applied either to the dimensions of the shutter elements or, in a reverse manner, on the dimensions of the radiation surfaces. In either case, if the correction factor is taken into account, the widths of the optical shutter elements or of the stripes in the example shown must be somewhat smaller than the width of the radiation surfaces, as the propagation channels are meant to taper in the direction of a viewer.

FIG. 3a illustrates the switching status of the shutter 3 in case view A₁ is displayed on the image display device 2. FIGS. 3b through 3d illustrate the corresponding status of the shutter 3 when the views A₂, A₃ or A₄, respectively, are displayed on the image display device 2. For each of the views, then, the specified and assigned propagation channels differ. As the time T is shorter than the time resolving power of the human eye, a viewer 4 can, in this way, see all views with full resolution. This is achieved thanks to the mask 12, through which only a small segment of each pixel Bᵢⱼ can be seen. Because of the effect of the shutter 3, each of these segments is made visible from certain directions only. The mask 12 may be fabricated by photolithography, but it may also be a sheet of exposed and developed photographic film.

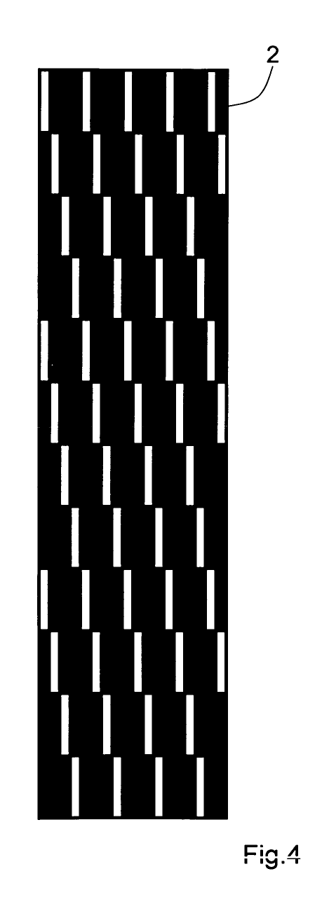

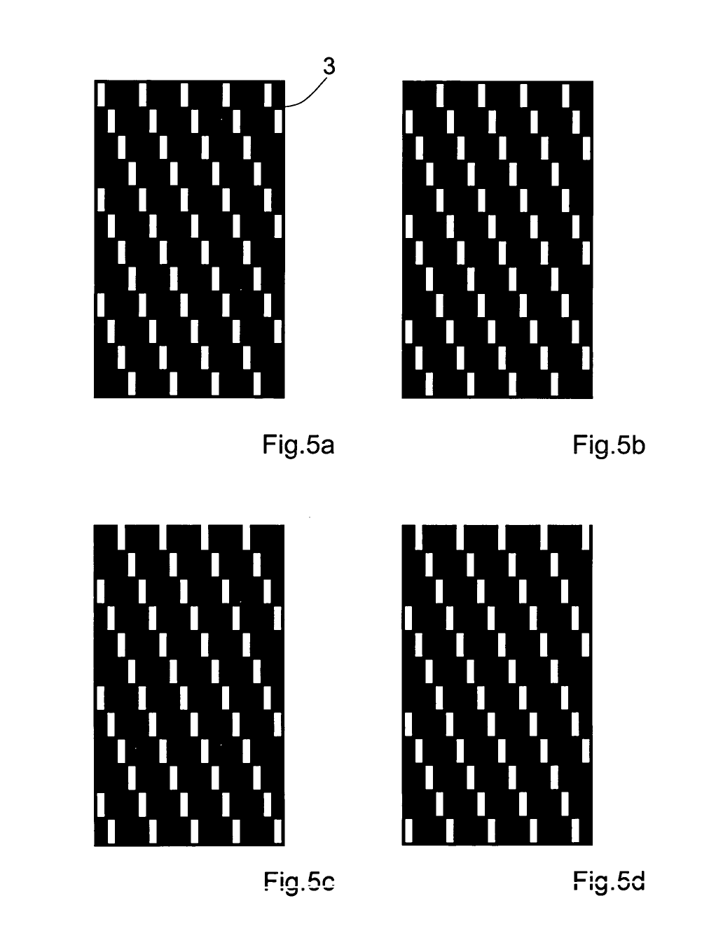

Another possibility of arranging the radiation surfaces on the pixels Bᵢⱼ of the image display device 2 is shown in FIG. 4. Here, the radiation surfaces are staggered from row to row, so that approximately a pattern of oblique stripes results. This has the advantage that the occurrence of so-called moiré fringes, if any, can possibly be prevented, and the combination of views or images can be varied. The shutter elements are then controlled accordingly; this is illustrated in FIGS. 5 through 5b. These figures show the shutter 3 in the differing switching statuses for the views A₁ through A₄, corresponding to the description for FIG. 3. Here again, the image display device 2 displays each view with full resolution. However, the switching statuses of the shutter 3 differ for each of the views, as shown in FIGS. 5a through 5d. Here again, channel separation is nearly complete.

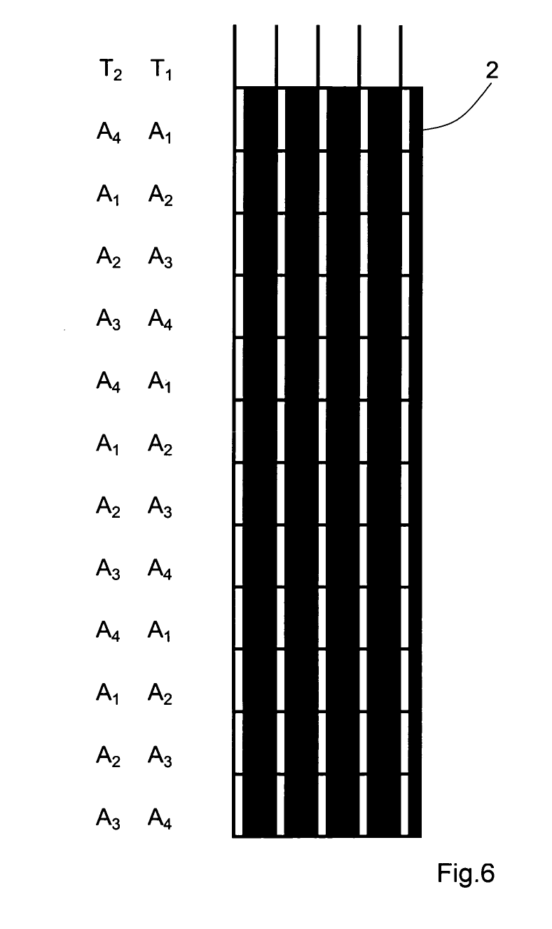

Another possibility of simultaneously displaying several views is suggested in FIG. 6. Here again, the pixels have the structure of vertical stripes auf. However, at a time cycle T now all four views are displayed simultaneously (in the example, each row shows only one view). The first row displays view A₁ in a first time T₁, the second row displays information from view A₂, the third row information from view A₃, etc. In a second time T₂, each of the views is displayed displaced downward by one row, as suggested in FIG. 6.

The switching statuses of the shutter elements vary accordingly; here, the shutter 3 described already in connection with FIG. 5 can be used with the switching statuses of shutter 3 shown in FIGS. 5a through 5d.

Obviously it is also possible to interleave the views in any manner; for this, the shutter 3 must be structured and switched accordingly.

While in case of the simultaneous display of views these are not shown with full resolution, this can be achieved on a time average if the times T are short enough so that, for example, each view is displayed on the image display device 2 once completely within a sixteenth of a second.

By means of the arrangement described, a spatial display of a scene comprising several views is possible with full resolution in an advantageous way, so that a viewer 4 need not put up with resolution losses compared to a two-dimensional display. This has a positive effect especially in switching between two-dimensional and three-dimensional display. Moreover, simultaneous display of two-dimensional and three-dimensional picture contents becomes possible with equal quality.

### LIST OF REFERENCES

1 control unit
2 image display device
3 shutter
4 viewer
5 illuminating device
6 lower polarizing filter
7 thin-film transistor matrix
8 electrode layer
9 liquid crystal layer
10 color filter layer
11 upper polarizing filter
12 mask

What is claimed is:

1. The invention relates to a method for the spatial display of a scene in which several views Aₖ of the scene, with k=1, . . . , N and N>1, are displayed in succession on a planar grid of pixels Bᵢⱼ with rows i and columns j,
and in which the total number of the rows and columns defines a resolution, and the grid has a total surface area and each pixel Bᵢⱼ has a pixel surface area, with the sum of all pixel surface areas yielding, in essence, the total surface area of the grid, and with each of the views Aₖ being displayed for a time T that is shorter than the time resolving power of the human eye,
and in which light is radiated by the pixels Bᵢⱼ from radiation surfaces,
and in which propagation channels for the radiated light that can be switched to be transmissive and opaque to light are assigned to and specified for each view Aₖ, such propagation channels differing from those assigned to the other views, so that a viewer (4), on a time average, will see predominantly or exclusively bits of partial information of a first selection from the views Aₖ with one eye and predominantly or exclusively bits of partial information from a second selection with the other eye, whereby a visual impression of space is made,
and in which, as a radiation surface of each pixel Bᵢⱼ, only a partial area is used, whose share in width is maximally 1/N, referred to the horizontal extension of the pixel surface area,
and in which at every time T those propagation channels are switched to be opaque to light which are assigned to such views Aₖ that are not displayed at this time.

2. A method as claimed in claim 1, characterized in that the propagation channels are switched to be optically transmissive or opaque to light by means of a shutter (3) that is arranged before or behind the grid and provided with controllable shutter elements.

3. A method as claimed in claim 2, characterized in that the shutter elements in the light-transmissive switching status open, for each of the respective pixels Bᵢⱼ, an area that has the height of the radiation surface and that has the width of the same save for a correction factor.

4. A method as claimed in claim 1, characterized in that each of the views is displayed for the time T with full resolution.

5. A method as claimed in claim 1, characterized in that M of the views Aₖ are displayed simultaneously, with M<N, and each of the M views Aₖ is, on a time average, displayed with full resolution for a time greater than T, preferably between M*T and N*T.

6. An arrangement for three-dimensional display of a scene, comprising
an image display device (2) with a grid of pixels Bᵢⱼ with rows i and columns j, on which several views Aₖ of the scene, with k=1, . . . , N and N>1, can be displayed in succession, each for a time T that is shorter than the time resolving power of the human eye, with the grid having a total surface area and each pixel Bᵢⱼ having a surface area, with the sum of all pixel surface areas yielding, in essence, the total surface area of the grid, and with the pixels Bᵢⱼ having radiation surfaces from which light is radiated,
a control unit (1), which assigns propagation channels for the radiated light to each view Aₖ, with the propagation channels assigned to a view Aₖ differing from the propagation channels for the other views, so that a viewer (4), on a time average, will see predominantly or exclusively bits of partial information of a first selection from the views Aₖ with one eye and predominantly or exclusively bits of partial information from a second selection with the other eye, whereby a visual impression of space is made,
a controllable shutter (3) for defining the propagation channels, which switches the propagation channels to be transmissive or opaque to light,
with the radiation surface of each pixel Bᵢⱼ being only a partial area of the pixel Bᵢⱼ, whose share in width is maximally 1/N, referred to the horizontal extension of the pixel surface area, and
with the shutter (3) being controlled by the control unit (1) in such a manner that at every time T those propagation channels are switched to be opaque to light which are assigned to such views Aₖ that are not displayed at this time.

7. An arrangement as claimed in claim 6, characterized in that on the image display device (2) a mask (12) is applied, which covers at least a share of (N−1)/N of the width of each of the pixel surface areas (referred to the horizontal extension) opaquely and the remaining share transmissively, with each transmissively covered share corresponding to a radiation surface.

8. An arrangement as claimed in claim 7, characterized in that the mask (12) is provided with a mirror coating on its side facing the image display device (2).

9. An arrangement as claimed in claim 6, characterized in that a mask (12) is applied on the side of the image display device (2) facing away from the viewer (4), which mask is dimensioned in such a way that the pixel surface areas are illuminated only in the area of their radiation surfaces.

10. An arrangement as claimed in claim 9, characterized in that the mask (12) is provided with a mirror coating on its side facing an illuminating device (5).

11. An arrangement as claimed in claim 6, characterized in that the shutter (3) is provided with individually controllable shutter elements, preferably optoelectronic shutter elements on a liquid crystal base.

12. An arrangement as claimed in claim 11, characterized in that the optoelectronic shutter elements, the mask (12) and the pixels Bᵢⱼ consist of materials the optical refractive indices of which differ from each other by less than 10%.

13. An arrangement as claimed in claim 6, characterized in that the pixels Bᵢⱼ are arranged on the grid periodically and are of polygonal shape.

14. An arrangement as claimed in claim 13, characterized in that the pixels Bᵢⱼ and the radiation surfaces are of rectangular shape and in that the heights of the radiation surfaces and the pixels Bᵢⱼ are equal and their widths relate as 1/N.

15. An arrangement as claimed in claim 14, characterized in that the shutter elements are configured as stripes of vertical orientation, the width of one stripe, with a correction factor taken into account, corresponds essentially to the width of the radiation surfaces, and the number of stripes is at least N times the number of pixels Bᵢⱼ in a row i of the grid.

16. An arrangement as claimed in claim 6, characterized in that the shutter (3) and/or the image display device (2) is provided with means to reduce unwanted light reflections, preferably at least one optical-interference antireflection coating layer.

17. An arrangement as claimed in claim 6, characterized in that the image display device (2) is configured as an LCD color screen, a plasma screen, a projection screen, or an LED, OLED, SED or VFD screen.

18. An arrangement as claimed in claim 6, characterized in that the pixels Bᵢⱼ are configured as R (red), G (green) or B (blue) subpixels, as combinations thereof, as full-color pixels and/or as combinations thereof.
